(19) United States
(12) Patent Application Publication
(10) Pub. No.: US 2026/0073525 A1
(43) Pub. Date: Mar. 12, 2026

(54) ANOMALY DETECTION METHOD BASED ON OUT-OF-DISTRIBUTION AND NON-TRANSITORY COMPUTER-READABLE MEDIUM

(71) Applicants: INVENTEC (PUDONG) TECHNOLOGY CORPORATION, Shanghai (CN); INVENTEC CORPORATION, Taipei City (TW)

(72) Inventors: Wei-Chao CHEN, Taipei City (TW); Jeng-Lin LI, Taipei City (TW); Nikita Mikhaylovich GALAYDA, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/984,632

(22) Filed: Dec. 17, 2024

(30) Foreign Application Priority Data
Sep. 11, 2024 (CN) 202411273951.6

(51) Int. Cl. G06T 7/11; G06T 7/174

(52) U.S. Cl. CPC G06T 7/11; G06T 7/174; G06T 2207/20081; G06T 2207/20221

(57) ABSTRACT

This anomaly detection method, based on out-of-distribution techniques, is executed by a computing device. It starts by obtaining a training dataset containing various images, including a first image and multiple second images. The method segments objects and contexts in each image, calculating the similarity between the object in the first image and those in the second images. A candidate image is selected if its similarity exceeds a predefined threshold. The object from the first image is blended with the context of the candidate image to produce a blended image. A detection model is then trained using this dataset. Subsequently, in-distribution embeddings are generated, and a test embedding is created. The test sample is classified as an anomaly when the minimum distance between the in-distribution embeddings and the test embedding exceeds a default value.

### CROSS-REFERENCE TO RELATED APPLICATIONS

This non-provisional application claims priority under 35 U.S.C. § 119(a) on Patent Application No(s). 202411273951.6 filed in China on Sep. 11, 2024, the entire contents of which are hereby incorporated by reference.

### BACKGROUND

### 1. Technical Field

The present disclosure relates to anomaly detection in images, particularly an anomaly detection method based on out-of-distribution.

### 2. Related Art

Anomaly detection plays a vital role in automation in various industries that detect data deviating significantly from normal behavior within a dataset. In various domains such as finance, cybersecurity, healthcare, and manufacturing, anomalies can signify critical events, errors, or fraudulent activities that demand attention. Although there are preliminary successes in anomaly detection in images using artificial intelligence (AI), several challenges have not been addressed in real-world scenarios.

In manufacturing, anomaly detection plays a crucial role in delivering functioning products on par with the quality standard. One of the anomaly detection methods is visually comparing the produced product with a “golden” standard. However, this difference-based algorithm can dramatically fail in cases where the images of the product have high variability in their contexts. For example, in electronic manufacturing, a motherboard consists of complex pieces of hardware components. The same types of components can be arranged in different locations based on the layout design. Moreover, the production lines may use different lighting and/or cameras, leading to vastly different images of the components. Providing golden images for anomaly detection in such variable contexts becomes impractical, as the background of the components includes high variability. To this end, current image anomaly detection algorithms merely address a constrained setting with standard golden images, strongly assuming the data are located in homogeneous backgrounds. This constraint also needs to separately perform anomaly detection for each class. Despite the recent technical progress attempts to enable a multi-class model, the limitation of same-context golden images has not been alleviated.

The robustness of current algorithms is significantly degraded in highly varied contexts due to the difficulty in specifying non-defective objects. Objects appear in imbalanced contexts lead to biased distribution and create varied visual appearances. Uncommon contexts are inclined to confuse the model to predict the image to be defective. Additionally, in the real world, it is challenging to fully collect data of every object in every background.

### SUMMARY

In light of the above descriptions, the present disclosure proposes an anomaly detection method based on out-of-distribution and a non-transitory computer-readable medium. The aim is to detect anomaly samples in diverse contexts that cannot directly apply traditional anomaly detection.

According to one or more embodiment of the present disclosure, an anomaly detection method based on out-of-distribution is performed by a computing device. This method includes the following steps: obtaining a training dataset comprising a plurality of images, wherein the plurality of images comprises a first image and a plurality of second images; segmenting an object and a context in each of the plurality of images; calculating a similarity between the object in the first image and the object in each of the plurality of second images; selecting a candidate image from the plurality of second images whose similarity exceeds a threshold; blending the object in the first image with the context in the candidate image to generate a blended image; training a detection model according to the training dataset and the blended image; executing the detection model to generate a plurality of in-distribution embeddings according to the plurality of images and the blended image, and generate a test embedding according to a test sample; calculating a plurality of distances between the in-distribution embeddings and the test embedding; and classifying the test sample as an anomaly when a minimum of the plurality of distances exceeds a default value

According to one or more embodiment of the present disclosure, a non-transitory computer-readable medium is configured to store a plurality of instructions. The plurality of instruction is performed by a computing device to cause a plurality of operations, comprising: obtaining a training dataset comprising a plurality of images, wherein the plurality of images comprises a first image and a plurality of second images; segmenting an object and a context in each of the plurality of images; calculating a similarity between the object in the first image and the object in each of the plurality of second images; selecting a candidate image from the plurality of second images whose similarity exceeds a threshold; blending the object in the first image with the context in the candidate image to generate a blended image; training a detection model according to the training dataset and the blended image; executing the detection model to generate a plurality of in-distribution embeddings according to the plurality of images and the blended image, and generate a test embedding according to a test sample; calculating a plurality of distances between the in-distribution embeddings and the test embedding; and classifying the test sample as an anomaly when a minimum of the plurality of distances exceeds a default value.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart of an anomaly detection method based on out-of-distribution according to an embodiment of the present disclosure;

FIG. 2 is a detailed flowchart of a step in FIG. 1;

FIG. 3 is a flowchart of a first embodiment of a step in FIG. 1; and

FIG. 4 is a flowchart of a second embodiment of a step in FIG. 1.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The objective of the present disclosure is to detect samples of objects with defects in images under various contexts, where these samples cannot be directly identified using traditional anomaly detection methods. The differences in contexts arise from the translation of the camera position when capturing images and the orientation of component installation. To address this, the present disclosure casts the anomaly detection problem with complex contexts as an out-of-distribution (OOD) detection problem, aiming to relax the constraint requiring golden images in anomaly detection. Non-defective images are regarded as in-distribution (ID) data, while defective images are regarded as OOD data. In this scenario, approaches to enhance the context variability of the ID training data becomes essential for a robust ID embedding space. Therefore, the anomaly samples can be identified as OOD cases based on embedding distance comparison.

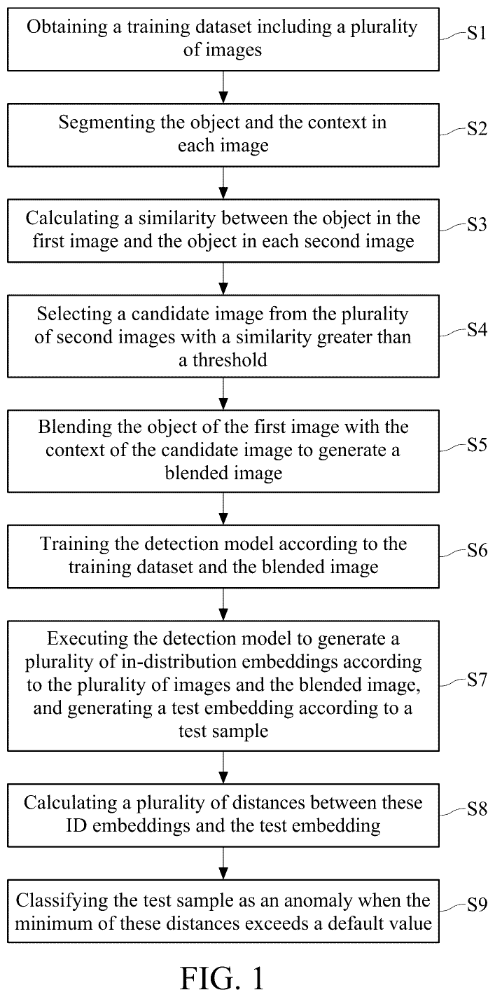

FIG. 1 is a flowchart of an anomaly detection method based on out-of-distribution according to an embodiment of the present disclosure. This method is performed by a computing device. In an embodiment, the computing device may be implemented using any of the following examples: personal computers, web servers, microcontrollers (MCUs), application processors (APs), field-programmable gate arrays (FPGAs), application-specific integrated circuits (ASICs), system-on-a-chip (SoC), deep learning accelerators, or any electronic device with similar functions. The present disclosure does not limit the hardware type of the computing device.

In step S1, the computing device obtains a training dataset that includes a plurality of images. In an embodiment, the computing device collects a context-varied component anomaly dataset from the outputs of an Automated Optical Inspection (AOI) machine, which includes, for example, 29896 images and 427 classes of components. Each image contains at least one target object to be detected with defects or no defects. The images are manually labeled during the manual motherboard inspection in real-world practice. In an embodiment, the dataset is split into a training set and a testing set, consisting of 25201 and 4695 images, respectively. The images in the training set belong to ID and contain only defect-free target objects, while the images in the testing set contain both ID and OOD data.

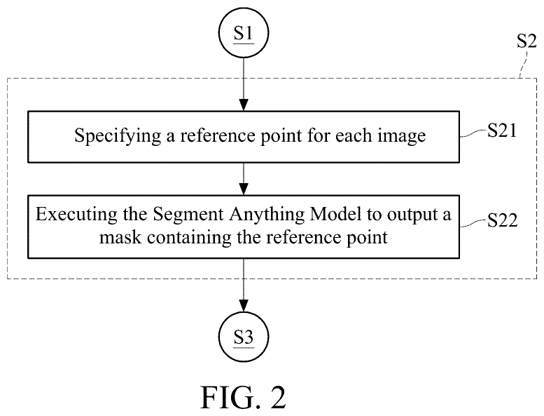

In step S2, the computing device segments the object and the context in each image. All images in the training dataset X={X₁, X₂, . . . , X_{N}} are segmented as objects and contexts forming a set of objects S={S₁, S₂, . . . , S_{N}} and a set of contexts C={C₁, C₂, . . . , C_{N}}. In an embodiment, the implementation of step S2 is illustrated in FIG. 2, which is a detailed flowchart of step S2 in FIG. 1. In step S21, the computing device specifies a reference point for each image, such as the center of the image. In step S22, the computing device executes a Segment Anything Model (SAM) to output a mask containing the reference point. The SAM is used to separate the foreground object from the background contexts.

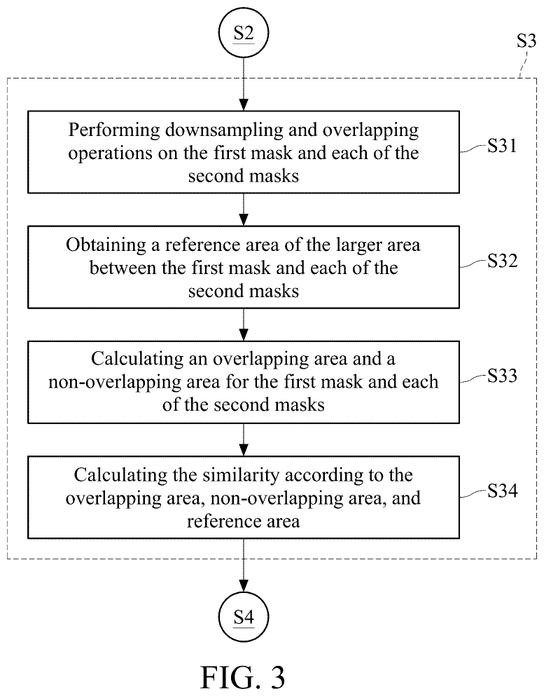

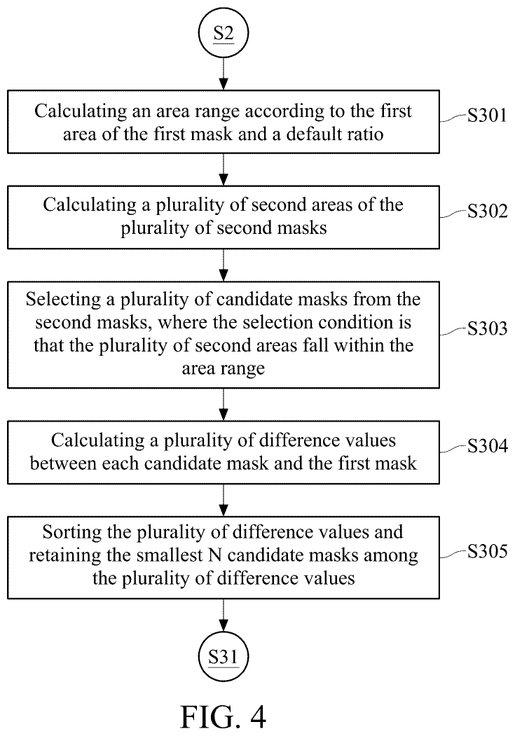

In step S3, the computing device calculates a similarity between the object in the first image and the object in each second image. For each training image, after obtaining the segmented objects, a context candidate set C′ is retrieved by constraining consistent object visual appearances. The present disclosure proposes three embodiments to calculate the similarity between two objects using the masks derived from SAM, with FIG. 3 and FIG. 4 illustrating the flowcharts for the first and second embodiments of step S3, respectively.

The custom-defined terms are explained as follows: “First image” refers to any image in the training dataset, and “second image” refers to any image in the training dataset other than the first image. “First/Second mask” refers to the mask output for the first/second image after step S2, and the mask is used to outline the object in the image.

The first embodiment of the similarity calculation uses the shape of the masks as the comparison basis. Please refer to FIG. 3 for the detailed process. In step S31, the computing device performs downsampling and overlapping operations on the first mask and each of the second masks. In step S32, the computing device obtains a reference area of the larger area between the first mask and each of the second masks. In Step s33, the computing device calculates an overlapping and a non-overlapping area for the first mask and each of the second masks. In step S34, the similarity is calculated according to the overlapping area, non-overlapping area, and reference area.

Overall, the computing device downsamples the masks while preserving their aspect ratio to retain the object shape. For each pair of masks (first mask and second mask), the computing device overlaps them using the smallest common area. A larger overlap is perceived as higher similarity between the two objects. The non-overlapping area is subtracted from the overlapping area, in order to account for vastly different shapes. The normalized difference is the similarity score between the two object masks. Given a mask image/with dimensions, its binary mask can be represented as a set of tuples M={(i, j)|I_{i,j}>t}, where t is a predetermined threshold for binarization. In an embodiment, t=200.

Given two masks Mₐ and M_{b}, the overlap similarity score is calculated as follows:

$${score}_{s i m i l arity} = \frac{{A}_{o}}{{C}_{max}} - \frac{{A}_{n}}{{C}_{max}}$$

where Aₒ=Mₐ∩M_{b}, Aₙ=(Mₐ\M_{b})∪(M_{b} \Mₐ) and Cₘₐₓ=max(|Mₐ|, |M_{b}|).

The second embodiment of the similarity calculation is an extension of the first embodiment. If the number of masks is large, the computation cost of the first embodiment may be high. To avoid similarity calculations between all masks, the second embodiment may narrow down the potentially similar masks beforehand by calculating the areas of masks. As shown in FIG. 4, prior to Step S31, steps 301-305 are included.

In step S301, the computing device calculates an area range according to the first area of the first mask and a default ratio. In an embodiment, the default ratio ϵ=0.05, and the area range is within ±5% of the first area.

In step S302, the computing device calculates a plurality of second areas of the plurality of second masks.

In step S303, the computing device selects a plurality of candidate masks from the second masks, where the selection condition is that the plurality of second areas fall within the area range.

In step S304, the computing device calculates a plurality of difference values between each candidate mask and the first mask. In an embodiment, the difference value is the absolute value of the area difference. In another embodiment, the difference value is the absolute difference in pixel count.

In step S305, the computing device sorts the plurality of difference values and retains the smallest N candidate masks among the plurality of difference values, where N is a positive integer. It then continues with the process from FIG. 3, calculating the similarity between the first mask and each of these N candidate masks.

The third embodiment of the similarity calculation uses cosine similarity. Cosine similarity is not computationally expensive and can be performed on very large sets of masks. First, an adjustment operation is performed to ensure that the first mask and each of the second masks have the same size (dimensions, width, and height). After completing the adjustment operation, the cosine similarity matrix between the first mask and each of the second masks is calculated as

$$\frac{A \cdot B}{‖ A ‖ ‖ B ‖} ,$$

serving as the similarity in step S3, where A and B represent an one-dimensional vector forms of the first and second masks, respectively.

In step S4, the computing device selects the candidate image(s) from the plurality of second images with a similarity greater than a threshold. The present disclosure does not limit the value of the threshold. In an embodiment, to avoid generating redundant blended images, the candidate image(s) will exclude the class to which the object of the first image belongs.

In step S5, the computing device blends the object of the first image with the context of the candidate image to generate a blended image. In an embodiment, the computing device applies Poisson blending P to smooth the boundary between the object of the first image and the context of the candidate image, \hat{x}ᵢ=P(sᵢ+cⱼ), this method introduces fewer artifacts in the image appearance.

Steps S1 to S5 outline the context augmentation method proposed by the present disclosure. For imbalanced object classes, this method can increase the variability of minority objects. The weight wₖ of the k-th class can be derived by

$${w}_{k} = \frac{1}{{N}_{k}} ,$$

where Nₖ represents the number of images in the k-th class. Then, normalization is performed according to the total class weight. Then, normalization is performed based on the total category weight. For example, a weight threshold w^{th} is set as a parameter, and additional augmentation is applied to one or more classes with a weight wₖ greater than the threshold w^{th}. The total amount of augmentation is determined by the parameter γ, which represents the augmentation ratio; for instance, γ=1 represents a 100% increase in the number of samples. It is noteworthy that context augmentation can still be applied to classes with a majority of samples, as the diversity of the contexts is generally greater than the sample space.

In step S6, the computing device trains the detection model according to the training dataset and the blended images. In an embodiment, the detection model belongs to a Multi-Geometry Projection (MGP) network and includes a plurality of branches. The detection model utilizes a backbone network combined with dual-stream geometry projections to capture diverse latent structures in the data. Each geometry stream is defined by its specific loss function for joint optimization. In an embodiment, the plurality of branches includes a hypersphere manifold and a hyperbolic manifold, both Riemannian manifolds with positive and negative curvature, respectively. The curvature serves as an indicator of deviation from the Euclidean space.

The hypersphere manifold includes compactness and disparity loss functions.

These functions ensure that samples from different classes are kept at sufficient distances from each other, and group the data samples onto a hypersphere.

In an embodiment, the computing device uses CIDER (Y. Ming, Y. Sun, O. Dia, and Y. Li, “How to Exploit Hyperspherical Embeddings for Out-of-Distribution Detection?,” in ICLR, 2023) to optimize compactness and disparity losses for a hypersphere manifold with a unit vector

$${z}_{s} ∈ {ℛ}_{s}^{d}$$

in class k, and the class prototype is defined as μₖ: p_{d}(zₛ; μₖ)=τ exp(μ_{kz}_{ₛ}/τ), where τ is a temperature parameter. The probability of the embedding zₛ assigned to class k is:

$$𝒫 ( y = k \vert {z}_{s} ; \{ {μ}_{k} , τ \} ) = \frac{exp ( {μ}_{k {z}_{s}} / τ )}{{\sum }_{j = 1}^{K} exp ( {μ}_{j {z}_{s}} / τ )}$$

In an embodiment, the computing device derives the compactness loss [symbol] _{com} by taking negative log-likelihood, which forces each sample to be located close to the prototype of its belonging class.

$${ℒ}_{c o m} = - \frac{1}{N} log \frac{exp ( {μ}_{k {z}_{s}} / τ )}{{\sum }_{j = 1}^{K} exp ( {μ}_{j {z}_{s}} / τ )}$$

The disparity loss [symbol] _{dis} encourages a large angular margin among class prototypes:

$${ℒ}_{d i s} = - \frac{1}{K} {\sum }_{i = 1}^{K} log \frac{1}{K - 1} {\sum }_{j = 1}^{K} {1}_{j i} exp ( {μ}_{i {μ}_{j}} / τ ) ,$$

where 1ⱼᵢ is indication function,

$${1}_{j i} = \{ \begin{matrix}1 if j \neq i \\ 0 otherwise\end{matrix}$$

The hypersphere loss function can be expressed as [symbol] ₛₚₕ= [symbol] _{com}+ [symbol] _{dis}. These two losses jointly shape the clusters on the hypersphere with intra-class compactness and inter-class disparity for normal data, and anomaly data have less chance to locate in the space near normal prototypes.

Hyperbolic manifold: A hyperbolic space with constant negative curvature Hyperbolic manifold: A hyperbolic space with constant negative curvature deviated from the Euclidean space is usually characterized with Poincare Ball

$$( {M}_{c}^{d} , {g}^{M} ) ,$$

by defining a manifold M^{d}={u∈R^{d}: c∥u∥<1} equipped with the Riemannian metric

$${g}^{M} ( u ) = {( {κ}_{u}^{c} )}^{2} {g}^{E} = {( \frac{2}{1 - c {‖ u ‖}^{2}} )}^{2} I ,$$

where

$$κ = \frac{2}{1 - c {‖ u ‖}^{2}}$$

is a conformal factor with curvature c and g^{E}=I is an Euclidean metric tensor. The manifold depends on the operations with Mobius gyrovector space including the Mobius addition ⊕_{c} and scalar multiplication ⊗_{c}, where u and v are vectors and w is a scalar.

$$u {⊕}_{c} v = \frac{( 1 + 2 c < u , v > + c {‖ v ‖}^{2} ) u + ( 1 + c {‖ u ‖}^{2} ) v}{1 + 2 c < u , v > + {c}^{2} {‖ u ‖}^{2} {‖ v ‖}^{2}}$$

$$w {⊕}_{c} u = \frac{1}{\sqrt{c}} tanh ( w \cdot arc tanh ( \sqrt{c} ‖ u ‖ ) )$$

The geometric distance between two points u and v is written in the following form:

$$D ( u , v ) = \frac{2}{\sqrt{c}} arc tanh ( \sqrt{c} ‖ - u {⊕}_{c} v ‖ )$$

The distance converges to 2∥u−v∥ with the curvature c→0 which is proportional to the case for Euclidean distance.

An Exponential map can transform a vector to the tangent space on the Poincaré ball. In an embodiment, the computing device generates the embedding vector v using a backbone network and transform the vector as the hyperbolic embedding with the exponential map

$${ε}^{c} ( v ) = tanh ( \sqrt{c} ‖ v ‖ ) \frac{v}{\sqrt{c} ‖ v ‖} .$$

Then, the computing device can derive Hyperbolic averaging with multiple hyperbolic embeddings via Einstein midpoint. The computing device can project the embedding from the Poincaré ball

$${M}_{c}^{d}$$

to the Klein model

$${K}_{c}^{d}$$

and calculate a simpler average form with the Klein coordinate:

$${u}_{k} = \frac{2 {u}_{D}}{1 + c {‖ {u}_{D} ‖}^{2}} , \overline{{u}_{K}} = \frac{{\sum }_{i = 1}^{m} {r}_{{iu}_{K , i}}}{{\sum }_{i = 1}^{m} {r}_{i}} ,$$

where rᵢ is the Lorentz factor. After deriving the average embedding in the Klein coordinate, the computing device transforms the space back to the Poincaré ball:

$$\overline{{u}_{D}} = \frac{\overline{{u}_{K}}}{1 + \sqrt{1 - c {‖ \overline{{u}_{K}} ‖}^{2}}}$$

With the available operations of the hyperbolic space, the computing device projects the latent embedding with a hyperbolic head to derive the embedding u on the Poincaré ball. With an augmented set [symbol] from [symbol] to form a full set [symbol] = [symbol] ∩χ. The augmented set [symbol] is generated by context augmentation combining with standard augmentation methods, including whole image cropping, flipping, and color jittering. The supervised contrastive loss is calculated on the positive sample p(i) of the i∈ [symbol] in contrast to other augmented samples a∈ [symbol] . Supervised hyperbolic contrastive loss can thus be formulated as:

$${ℒ}_{hypb} = - {\sum }_{i ∈ 𝒥} \frac{1}{\vert P ( i ) \vert} {\sum }_{p ∈ P ( i )} log \frac{exp ( - D ( {z}_{i} , {z}_{{h}_{p}} ) / τ )}{{\sum }_{a ∈ \hat{X}} exp ( - D ( {z}_{{h}_{i}} , {z}_{{h}_{a}} ) / τ )}$$

The final loss [symbol] used to optimize the accuracy of ID classification is the combination of the hypersphere loss [symbol] ₛₚₕ and hyperbolic loss [symbol] _{hypb} along with a cross-entropy loss [symbol] _{ce}: [symbol] = [symbol] ₛₚₕ+ [symbol] _{hypb}+ [symbol] _{ce}. The curvature parameter c is usually deemed as a hyperparameter. In an embodiment, the Gromov product mentioned in the following reference is used to estimate the value of c: V. Khrulkov, L. Mirvakhabova, E. Ustinova, I. Oseledets, and V. Lempitsky, “Hyperbolic image embeddings,” in CVPR, 2020.

For the stability of learning, in an embodiment, the feature clipping technique is adopted. This technique is empirically found useful for better convergence and to avoid the gradient vanishing of complex manifold learning. An Euclidean space sample point x is truncated as the clipped feature

$${x}^{′} = min \{ 1 , \frac{r}{‖ x ‖} \} \cdot x$$

with the effective radius r of the Poincaré ball. This process regularizes the points sitting overly close to the ball boundary.

Please refer to FIG. 1. In step S7, the computing device executes the detection model to generate a plurality of ID embeddings according to the plurality of images and blended images, and generate a test embedding according to a test sample. In step S8, the computing device calculates a plurality of distances between these ID embeddings and the test embedding. In step S9, the computing device classifies the test sample as an anomaly when the minimum of these distances exceeds a default value.

For anomaly detection, the objective of the present disclosure is to identify anomalies A from normal data N. Input data x∈ [symbol] are fed into the detection model f: χ> [symbol] to predict label y∈ [symbol] , where [symbol] ={N, A}. Due to the context-varied anomaly detection setting, data x drawn from the marginal distribution P_{χ} contain different backgrounds, object sizes, and positions. Therefore, traditional anomaly approaches using a golden image are not applicable.

The process from steps S7 to S9 depends on the OOD detection setting, where the normal data distribution

$${P}_{X}^{N}$$

is regarded as ID data and the anomalous data distribution

$${P}_{X}^{A}$$

is regarded as OOD data. During the training process, only the ID data

$${P}_{X}^{N}$$

and its label [symbol] ={N} are used. In the testing phase, normal test data and OOD data from the anomalous data distribution

$${P}_{X}^{A}$$

will be observed. In this way, anomaly detection can be performed using an OOD detection algorithms according to the comparison of the normal data distribution

$${P}_{X}^{A}$$

with the test samples rather than the use of golden images. This transformed anomaly detection method is different from the original OOD setting that differentiates ID and OOD samples in the prediction classes. For example, [symbol] ^{ID}={y₁, y₂, . . . , y_{K}} with K classes and [symbol] ^{OOD} contains any class other than the K classes in [symbol] ^{ID}, resulting a disjoint class set. In an embodiment, both the normal data distribution

$${P}_{X}^{N}$$

and anomalous data distribution

$${P}_{X}^{A}$$

contain a plurality of classes.

In step S6, the detection model f is trained using ID data x drawn from the marginal distribution P_{χ} and yields a plurality of ID embedding z in step S7. The objective of the present disclosure is to detect anomaly samples from anomalous data distribution

$${P}_{X}^{A}$$

during inference. In steps S8 and S9, the estimator g used for OOD detection is implemented based on the score function S(z) and a default value λ:

$${g}_{λ} ( z ) = \{ \begin{matrix}Normal & if S ( z ) \leq λ \\ Anomaly & otherwise\end{matrix}$$

The standard steps to detect OOD are as follows: First, train the detection model f using ID data and freeze the model parameters (step S6). Second, input the test sample into the frozen model (step S7). Third, calculate the OOD score and use the default value λ to identify anomaly samples (steps S8 and S9).

In an embodiment, the computing device extracts the penultimate layer output of the detection model f in step S7 as an L2 normalized embedding z for the sample x. To differentiate between OOD samples and ID samples, the computing device calculates the embedding distance between each ID embedding z_{ID} and the test embedding zₜₑₛₜ in step S8, setting the one with the smallest distance as the reference embedding z₀. Then, based on the L2 distance, the OOD score is calculated as S(z)=∥zₜₑₛₜ−z₀∥², and the estimator g compares the OOD score S(z) with the default value λ to achieve anomaly detection.

An embodiment of the present disclosure includes a non-transitory computer-readable medium configured to store a plurality of instructions. In an embodiment, the non-transitory computer-readable medium may be implemented by various physical storage devices, including hard disk drives (HDDs), solid-state drives (SSDs), optical discs such as CDs, DVDs, or Blu-ray discs, USB flash drives, memory cards like SD cards, read-only memory (ROM), and embedded flash memory. The plurality of instruction is performed by a computing device to cause a plurality of operations. The plurality of operations corresponds to the steps of performing the anomaly detection method based on out-of-distribution according to an embodiment of the present disclosure, including: obtaining a training dataset comprising a plurality of images, wherein the plurality of images comprises a first image and a plurality of second images; segmenting an object and a context in each of the plurality of images; calculating a similarity between the object in the first image and the object in each of the plurality of second images; selecting a candidate image from the plurality of second images whose similarity exceeds a threshold; blending the object in the first image with the context in the candidate image to generate a blended image; training a detection model according to the training dataset and the blended image; executing the detection model to generate a plurality of in-distribution embeddings according to the plurality of images and the blended image, and generate a test embedding according to a test sample; calculating a plurality of distances between the in-distribution embeddings and the test embedding; and classifying the test sample as an anomaly when a minimum of the plurality of distances exceeds a default value.

In the aforementioned operations, segmenting the object and the context in each of the plurality of images comprises includes the following steps: specifying a reference point in the plurality of images; and executing a segment anything model to output a first mask and a plurality of second masks, wherein each of the first mask and the plurality of second masks contains the reference point, the first mask corresponds to the object in the first image, and one of the plurality of second masks corresponds to the object in one of the plurality of second images.

In the aforementioned operations, calculating the similarity between the object in the first image and the object in each of the plurality of second images includes the following steps: performing downsampling and overlapping operations on the first mask and each of the plurality of second masks; obtaining a larger area between the first mask and each of the plurality of second masks as a reference area; calculating an overlapping area and a non-overlapping area for the first mask and each of the plurality of second masks; and calculating the similarity according to the overlapping area, the non-overlapping area, and the reference area.

To evaluate the anomaly detection method based on OOD proposed in the present disclosure, three common OOD detection metrics are used, which are also indicators for image-level anomaly detection:
(1) False Positive Rate (FPR) when the true positive rate equals 95%.
(2) Area Under the ROC (AUC), where ROC stands for Receiver Operating Characteristic.
(3) Area Under the Precision and Recall curve (AUPR).

TABLE 1

| Model | Mask | Augment | AUPR | AUC | FPR |
|---|---|---|---|---|---|
| CIDER | none | none | 67.27% | 95.27% | 77.21% |
| MGP | none | none | 73.58% | 95.92% | 48.90% |
| CIDER | Overlay | none | 75.79% | 95.07% | 65.47% |
| CIDER-Reweight | Random | none | 73.62% | 96.32% | 60.83% |
| CIDER | Random | none | 80.49% | 96.52% | 72.61% |
| CAEL-CIDER | Context | γ = 1, | 84.86% | 97.46% | 50.24% |
| | | wₜₕ > 0.2 | | | |
| CAEL-MGP | Context | γ = 1, | 75.93% | 96.51% | 42.36% |
| | | wₜₕ > 0.2 | | | |

Table 1 uses the AOI dataset mentioned earlier to evaluate anomaly detection under context variations, where the anomaly detection method based on OOD proposed in the present disclosure is referred to as the Context-Augmented Embedding Learning (CAEL) framework. In Table 1, two embedding-based methods are compared: CIDER and MGP, as network learning approaches. Considering the imbalanced data, the performances of various augmentation and reweighting approaches are also investigated in Table 1. For example, CIDER-reweight involves reweighting sample losses using the previously mentioned class weights wₖ. The second column of Table 1 lists the approaches for applying masks, including overlaying, random overlaying, and the proposed context augmentation approaches. The overlaying strategy directly overlays the mask with the image and thus enforces the model to focus on the image pattern on the object. The random overlaying strategy randomly selects the masks with different confidence generated by the SAM to perform overlay.

As shown in Table 1, the combination of CIDER and MGP networks within CAEL has achieved improvements across all three metrics, where the proposed CAEL-CIDER framework achieves 50.24% FPR, 97.46% AUC, and 84.86% AUPR in detecting defective anomalies. The CAEL-MMEL attains 42.36% which outperforms the other methods. The benefits of CAEL can both be observed using the CIDER and MMEL networks. The improvements of CAEL-CIDER relative to CIDER in AUPR, AUC, and FPR are 17.59%, 5.19%, and 26.97%, showing the advantage of context augmentation.

TABLE 2

| Experiment | Samples | AUPR | AUC | FPR |
|---|---|---|---|---|
| All | 4695 | 75.93% | 96.51% | 42.36% |
| Top 100 classes | 4085 | 93.15% | 98.40% | 33.83% |
| Top 80 classes | 3894 | 93.80% | 98.59% | 30.95% |
| Top 60 classes | 3592 | 94.43% | 98.79% | 27.26% |
| Tail 300 classes | 446 | 80.02% | 81.32% | 99.55% |

Regarding the anomaly detection results under different data distributions, Table 2 presents the evaluation results of CAEL-MGP for classes with varying sample sizes. Table 2 presents the top 100, 80, and 60 primary classes with the highest sample counts, as well as the tail 300 classes with the fewest samples. Specifically, the classes are ranked according to their sample sizes, selecting the top 100, top 80, and top 60 classes. When fewer classes are chosen, each classes in the training dataset contains a greater number of samples. Conversely, the tail 300 classes are selected to represent those with fewer samples.

Overall, the CAEL framework contains segmentation of objects and contexts for context augmentation in the training phase. Based on the segmented objects in the whole training dataset, the computing device can search for similar objects in the dataset with similar shape and size for each specified object. Therefore, each object in the image associating with another similar object that might locate in a different context. The computing device retrieves the contexts of these found similar objects to augment the query object and generate new images by performing Poisson blending. These new images augment the training data and diversify the context of each object in the dataset. In some embodiment, the computing device also performs standard data augmentation including random flipping, cropping, and adding color jittering to increase training robustness.

In view of the above description, the anomaly detection method based on out-of-distribution proposed in the present disclosure can improve detection accuracy by introducing context augmentation and multi-geometry projection networks, enabling more effective differentiation of abnormal samples and achieving higher accuracy compared to traditional methods. Additionally, through the design of context augmentation and class weights, the method addresses the issue of insufficient category data, reducing biases in anomaly detection caused by data imbalance.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. An anomaly detection method based on out-of-distribution performed by a computing device and comprising:
obtaining a training dataset comprising a plurality of images, wherein the plurality of images comprises a first image and a plurality of second images;
segmenting an object and a context in each of the plurality of images;
calculating a similarity between the object in the first image and the object in each of the plurality of second images;
selecting a candidate image from the plurality of second images whose similarity exceeds a threshold;
blending the object in the first image with the context in the candidate image to generate a blended image;
training a detection model according to the training dataset and the blended image;
executing the detection model to generate a plurality of in-distribution embeddings according to the plurality of images and the blended image, and generate a test embedding according to a test sample;
calculating a plurality of distances between the in-distribution embeddings and the test embedding; and
classifying the test sample as an anomaly when a minimum of the plurality of distances exceeds a default value.

2. The anomaly detection method based on out-of-distribution of claim 1, wherein segmenting the object and the context in each of the plurality of images comprises:
specifying a reference point in the plurality of images; and
executing a segment anything model to output a first mask and a plurality of second masks, wherein each of the first mask and the plurality of second masks contains the reference point, the first mask corresponds to the object in the first image, and one of the plurality of second masks corresponds to the object in one of the plurality of second images.

3. The anomaly detection method based on out-of-distribution of claim 2, wherein calculating the similarity between the object in the first image and the object in each of the plurality of second images comprises:
performing downsampling and overlapping operations on the first mask and each of the plurality of second masks;
obtaining a larger area between the first mask and each of the plurality of second masks as a reference area;
calculating an overlapping area and a non-overlapping area for the first mask and each of the plurality of second masks; and
calculating the similarity according to the overlapping area, the non-overlapping area, and the reference area.

4. The anomaly detection method based on out-of-distribution of claim 3, before calculating the overlapping area and the non-overlapping area for the first mask and each of the plurality of second masks, further comprising:
calculating an area range according to a first area of the first mask and a default ratio;
calculating a plurality of second areas of the plurality of second masks;
selecting a plurality of candidate masks from the plurality of second masks according to a condition, where the condition is that the plurality of second areas fall within the area range; and
calculating a plurality of difference values between each of the plurality of candidate masks and the first mask; and
sorting the plurality of difference values and retaining the smallest N candidate masks among the plurality of difference values, wherein N is a positive integer.

5. The anomaly detection method based on out-of-distribution of claim 2, wherein calculating the similarity between the object in the first image and the object in each of the plurality of second images comprises:
performing an adjustment operation so that the first mask and each of the plurality of second masks have the same size; and
calculating a cosine similarity between the first mask and each of the plurality of second masks as the similarity after the adjustment operation.

6. The anomaly detection method based on out-of-distribution of claim 1, wherein blending the object in the first image with the context in the candidate image to generate the blended image comprises: applying Poisson blending to smooth a boundary between the object in the first image and the context.

7. The anomaly detection method based on out-of-distribution of claim 1, wherein the detection model comprises a and a hypersphere branch and a hyperbolic manifold branch.

8. A non-transitory computer-readable medium configured to store a plurality of instructions, wherein the plurality of instruction is performed by a computing device to cause a plurality of operations, comprising:
obtaining a training dataset comprising a plurality of images, wherein the plurality of images comprises a first image and a plurality of second images;
segmenting an object and a context in each of the plurality of images;
calculating a similarity between the object in the first image and the object in each of the plurality of second images;
selecting a candidate image from the plurality of second images whose similarity exceeds a threshold;
blending the object in the first image with the context in the candidate image to generate a blended image;
training a detection model according to the training dataset and the blended image;
executing the detection model to generate a plurality of in-distribution embeddings according to the plurality of images and the blended image, and generate a test embedding according to a test sample;
calculating a plurality of distances between the in-distribution embeddings and the test embedding; and
classifying the test sample as an anomaly when a minimum of the plurality of distances exceeds a default value.

9. The non-transitory computer-readable medium of claim 8, wherein segmenting the object and the context in each of the plurality of images comprises:
specifying a reference point in the plurality of images; and
executing a segment anything model to output a first mask and a plurality of second masks, wherein each of the first mask and the plurality of second masks contains the reference point, the first mask corresponds to the object in the first image, and one of the plurality of second masks corresponds to the object in one of the plurality of second images.

10. The non-transitory computer-readable medium of claim 9, wherein calculating the similarity between the object in the first image and the object in each of the plurality of second images comprises:
performing downsampling and overlapping operations on the first mask and each of the plurality of second masks;
obtaining a larger area between the first mask and each of the plurality of second masks as a reference area;
calculating an overlapping area and a non-overlapping area for the first mask and each of the plurality of second masks; and
calculating the similarity according to the overlapping area, the non-overlapping area, and the reference area.
